(19) United States
(12) Patent Application Publication
(10) Pub. No.: US 2008/0305309 A1
(43) Pub. Date: Dec. 11, 2008

(54) COATING COMPOSITIONS, PROCESS AND LUMINESCENT COATED ARTICLES

(76) Inventor: DAMIEN F. REARDON, WILMINGTON, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/759,969

(22) Filed: Jun. 8, 2007

(51) Int. Cl. C09D 5/22; B05D 3/00; C09K 11/06

(52) U.S. Cl. 428/195.1; 106/31.97; 252/301.16; 252/301.35; 427/384

(57) ABSTRACT

The invention is directed to a composition having a carrier and a luminescent chelate wherein the lanthanide chelate being a lanthanide and a ligand wherein the ligand being represented by the formula

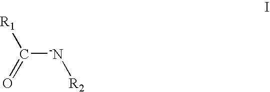

wherein R₁ is alkyl, aryl, or heteroaryl; and R₂ is alkyl, aminoalkyl, aryl or heteroaryl. The invention is further directed to a process for coating articles.

### FIELD OF THE INVENTION

The present invention is directed to coating compositions, such as, inks and paints that provide luminescent coatings on an article. The luminescent species is a rare-earth chelate with amide ligands. The invention is useful for providing identifying markers on articles. Other uses include the preparation of phosphors for plasma displays.

### BACKGROUND OF THE INVENTION

Luminescent rare-earth chelates are known. Certain rare-earth chelates will exhibit luminescence in the visible portion of the spectrum when exposed to ultraviolet light.

Rare-earth (or lanthanide) metal ions are absorbent in the ultraviolet; some luminance in the visible, some in the infrared. It is also known that when a rare-earth is complexed with certain organic ligands luminescence quantum yield of the rare-earth can be greatly enhanced by the broad band absorbance of the organic moiety in the ultraviolet spectrum which can efficiently transfer non-radiative energy to the rare-earth ion which then luminesces.

Each rare-earth element when incorporated into a chelate structure exhibits a characteristic excitation spectrum and emission or luminescence spectrum. Each such spectrum consists of a plurality of peaks at different wavelengths of light. The wavelengths at which the peaks occur are characteristic of each rare-earth element. The excitation spectrum is determined by monitoring the luminescence intensity at one wavelength while the specimen is illuminated over a range of wavelengths. The luminescence spectrum is determined by illuminating the specimen at a single wavelength corresponding to a peak in the excitation spectrum and determining the luminescence spectrum by scanning a detector over a range of wavelengths. No two rare-earth elements exhibit the same excitation or emission spectra; that is, the peaks in their spectra do not in general arise at the same wavelengths. These and related matters are all well-documented.

Mathur et al., Synth. React. Inorg. Met.-Org. Chem. 11(3), 231-244 (1981) discloses lanthanide chelates wherein the associated ligands are represented by the formula R₁NHC(O)R₂ wherein R₁ is phenyl, chloro-phenyl, or nitro-phenyl, and R₂ is methyl or phenyl with the proviso that when R₂ is phenyl, R₁ is unsubstituted phenyl. The lanthanide chelates disclosed were employed for infrared spectroscopic studies.

Therefore, many types of ligands are known in the art for use in forming chelates with rare-earth metals, and, even more generally, with transition metals. Despite this plethora of compositions, there is a continuing need for rare-earth chelates that luminesce with high quantum yield, particularly in the visible part of the light spectrum, and that exhibit thermal stability for processability and extended use temperatures.

### SUMMARY OF THE INVENTION

The invention is directed to a composition comprising a carrier and a luminescent chelate wherein the lanthanide chelate comprises a lanthanide and a ligand wherein the ligand being represented by the formula

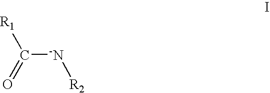

wherein R₁ is alkyl, aryl, or heteroaryl; R₂ is alkyl, aminoalkyl; aryl or heteroaryl.
Further provided is a process comprising depositing on at least a portion of a surface of an article a composition comprising
a carrier and a luminescent chelate, the luminescent chelate comprising a lanthanide and a ligand the ligand being represented by the formula

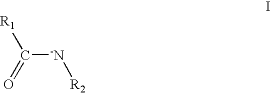

wherein R₁ is alkyl, aryl, or heteroaryl; R₂ is alkyl, aminoalkyl; aryl or heteroaryl, thereby forming upon the surface a coating comprising the luminescent chelate, optionally drying the composition.

Further provided according to the present invention is an article having a surface comprising a coating on at least a portion of the surface wherein the coating comprises
a carrier and a luminescent chelate forming a coating, the luminescent chelate comprising a lanthanide and a ligand, the ligand being represented by the formula

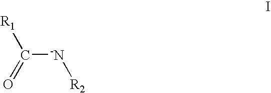

wherein R₁ is alkyl, aryl, or heteroaryl; R₂ is alkyl, aminoalkyl; aryl or heteroaryl, optionally drying the coating.

### DETAILED DESCRIPTION

The term “ligand” as found herein refers to an organic amide compound that can bond to a lanthanide metal by overlap of an empty orbital on the metal with a filled orbital on the ligand. The bonded anionic ligand is called the amidate. The “amide” is the neutral “protonated” ligand and the “amidate” is its “anionic” counterpart which has been deprotonated and bears a delocalized negative charge through its resonance structure, as indicated by the structures:

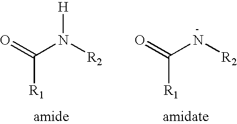

The term “chelate” means an inorganic complex formed between a lanthanide metal and a ligand that has a plurality of binding sites and wherein the ligand is bound to the metal at two or more of the binding sites of the ligand.

The compositions are useful for formulating coating compositions, including inks, paints, suitable for use in applying coatings on the surface of articles. Because of their thermal stability, the compositions of the present invention are well-suited for use in melt coating operations, high temperature curing, and use conditions in which the coated article is subject to temperatures of c.a. 150° C. for prolonged periods.

The structure represented by structure (I) is found in the art to be a resonant structure, as indicated by the following equilibrium reaction:

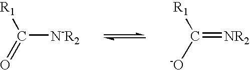

Throughout the present invention, structure (I) will be employed to represent both resonant structures.

The present invention provides a composition comprising a carrier and a luminescent chelate dispersed or dissolved therein, the luminescent chelate comprising a lanthanide chelate comprising a lanthanide and a ligand that together form a chelate structure, the ligand being represented by the structure

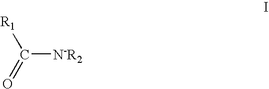

wherein R₁ is alkyl, aryl, or heteroaryl; R₂ is alkyl, aminoalkyl; aryl or heteroaryl, the luminescent chelate exhibiting a luminescence spectrum having a plurality of intensity peaks at characteristic wavelengths.

Any lanthanide except promethium and lutetium is satisfactory for use in the present invention. Preferred lanthanides are those that luminesce in the visible portion of the electromagnetic spectrum, including europium, dysprosium, samarium, terbium. Suitable lanthanides are in the +3 valence states. In one embodiment, the lanthanide is selected from Eu³⁺, Dy³⁺, Tb³⁺, and Sm³⁺.

Suitable aryls include but are not limited to phenyl, napthyl, anthracyl, or phenanthrenyl. Suitable heteroaryls include but are not limited to pyridinyl, quinolinyl, thionyl, furanyl, pyrolyl, oxazolyl, imidazolyl, pyrimidinyl, purinyl, nucleosides or keto tautomers of their enol forms. Suitable aryls or heteroaryls include substituted aryls or heteroaryls. All aromatic compositions described herein may be substituted or unsubstituted. Examples of substituents include but are not limited to the radicals such as alkyl, aryl, halo, alkoxy, halogenated alkyl, sulfanyl, secondary amino, or nitro.

Suitable aminoalkyl groups are represented by the formula

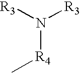

wherein each R₃ can independently be C1-C8 alkyl, preferably C1-C3, and R₄ can be C1-C8 alkenyl, preferably C2-C4. Most preferably, R₃ is methyl, and R₄ is ethenyl.

Ligands suitable for use in the invention include but are not limited to those represented by the formulae following, wherein Q can be O or S. Further, any six ring aryl structure can be replaced by a pyridinyl ring. Any of the aromatic rings can also have substituents including but not limited to alkyl, aryl, halo, alkoxy, halogenated alkyl, sulfanyl, secondary amino, or nitro.

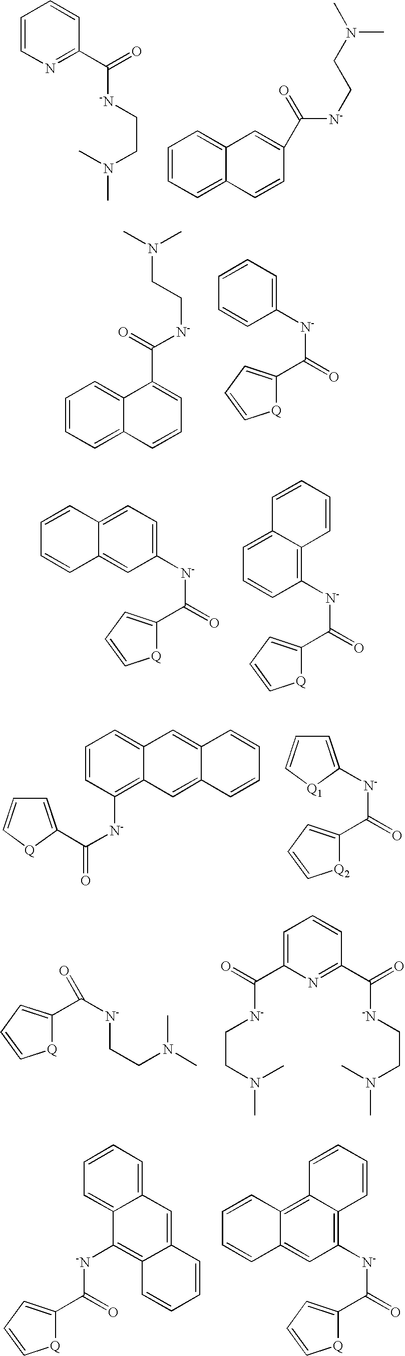

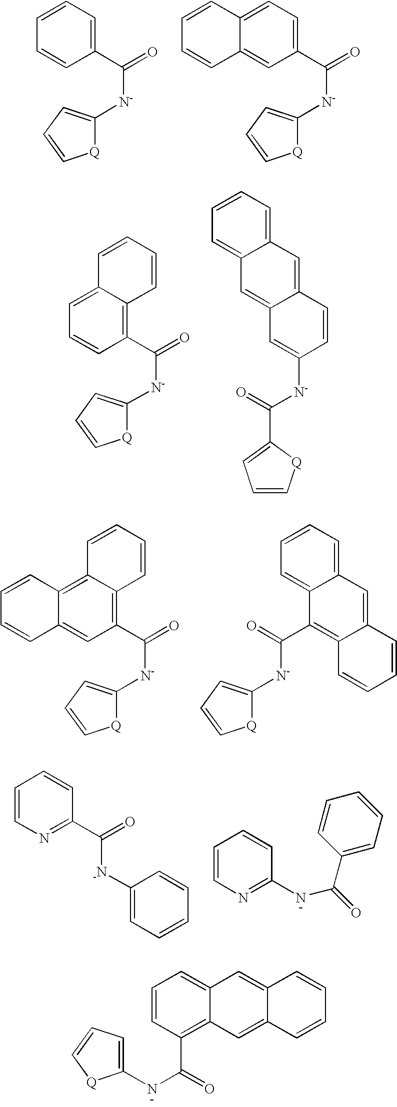

Also included are ligands having multiple heteroatoms in the aryl ring. For example pyrimidine, thiazole, oxazole, pyrrole, oxazole, imidazole, pyrimidine, purine, nucleosides or keto tautomers of their enol forms may be substituted for any of the aryl rings.

Embodiments of combinations of R₁ and R₂ in the anionic amidate ligand useful in the present invention are recited in Table 1.

TABLE 1

| R₁ | R₂ |
|---|---|
| Heteroaromatic ring | Aromatic ring |
| Heteroaromatic ring | Dialkylaminoethyl group |
| Aromatic ring | Dialkylaminoethyl group |
| Aromatic ring | Aromatic ring |
| Aromatic ring | Heteroaromatic ring |

Preferably the heteroaryl ring is thiophenyl, pyridinyl or furanyl. Preferably the aryl ring is phenyl, naphthyl, anthracyl, or phenanthranyl. Preferably, the dialkylaminoalkyl group is dialkylaminoethyl. More preferably the dialkylaminoethyl is dimethylaminoethyl.

Also included in the composition of the present invention are lanthanide amidate complexes in combination with coordinating ligands including but not limited to heteroaryl rings, substituted or unsubstituted, such as pyridine, pyridine-N-oxide, thiophene, furane, ketones, 1,10-phenathroline, tri-substituted phosphine oxides and di-substituted ethylene bridged di-phosphine oxides. Suitable coordinating neutrally charged ligands are represented in the following structures:

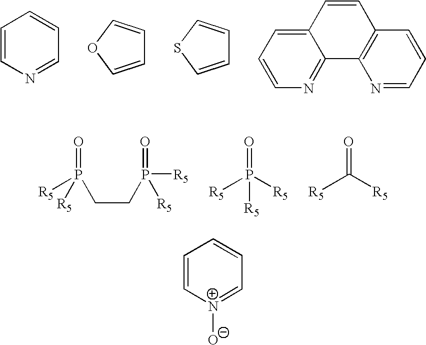

wherein each R₅ can independently be aryl or C1-C6 alkyl.

Coordination of these neutral ligands to the tris amidato lanthanide in the mole ratio range of 1:1 or 1:2 will yield the following representative structures:

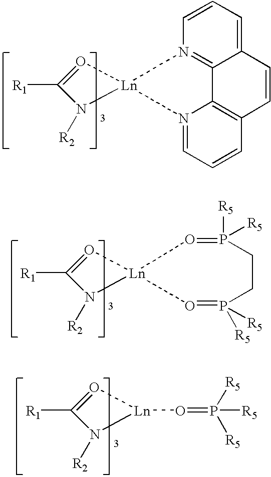

wherein R₁ is alkyl, aryl, or heteroaryl; R₂ is alkyl, aminoalkyl; aryl or heteroaryl, and each R₅ can independently be aryl or C1-C6 alkyl.

For the purposes of the present invention, the term “carrier” refers to a continuous medium within which the luminescent chelate is dissolved or dispersed. The carrier can comprise a liquid, a polymer or both.

The present invention encompasses both solutions and dispersions of the luminescent chelate in the carrier. Dispersions of finely divided particulate luminescent chelates in non-solvents may be employed as commonly done in the art. Methods routinely employed in the art for preparation of dispersions using insoluble pigments may be employed to produce coating compositions according to the present invention.

Suitable liquid carriers include but are not limited to water, alkanes such as hexane; alcohols; aldehydes; ketones; ethers, such as dipropylene glycol monomethyl ether; esters, such as ethyl acetate, propyl acetate, or dipropylene glycol monomethyl ether acetate; nitrites, amides, aromatics such as toluene; and mixtures thereof. Water and alcohols are preferred. In one embodiment, methanol, ethanol, propanols, butanols, or mixtures thereof are employed. In another embodiment, water is employed. In a further embodiment, a mixture of alcohol and water is used as the carrier liquid. Preferred carrier liquids include acetone, methyl-ethyl ketone, methanol, ethanol, propanol, butanol, 1,2-ethanediol, 1,2-propanediol, 1,3-propanediol, 2-methoxypropanol, 2-methoxyethanol, 3-methoxypropanol, ethylene glycol dimethyl ether, ethylacetate, toluene and water. Other useful liquids include terpineol, toluene, xylene, dimethylformamide, pyridine, ethylbenzene, carbon disulfide, 1-nitropropane, and tributylphosphate.

Useful polymers for systems in which the carrier liquid is aqueous include, but are not limited to poly(ethylene oxide), poly(acrylamide), poly(vinylpyrrolidone), poly(vinyl alcohol) and poly(vinyl acetate). Included in each of these terms are both homo- and copolymers of the primary monomers, as well as mixtures thereof.

Useful polymers for use in carrier liquids based upon non-aqueous solvents include, but are not limited to cellulosic polymers, poly(alpha-olefins) where the olefins contain six or more carbon atoms when used in conjunction with non-polar solvents such as alkanes; acrylic polymers when used in conjunction with polar organic solvents such as esters, ketones, and glycol- and other ethers. Esters include but are not limited to ethyl acetate, butyl acetate, butyl cellosolve acetate; carbitol esters; ketones include but are not limited to acetone, methylethylketone, diisopropylketone, and cyclohexanone. Ethers include but are not limited to tetrahydrofuran, dioxane, tetrahydrofurfural alcohol.

Mixtures of polymers are also suitable. Mixtures of polymers often provide a more desirable combination of properties than can be obtained from a single polymer.

Preferably the polymer is soluble in the carrier liquid. However, the polymer can be present as a dispersion in the carrier liquid as well.

One fundamental requirement for the polymer employed herein is that the polymer can not exhibit significant absorbance at either the excitation or emission wavelengths of interest because of interference with the intensity of the observed luminescence.

Numerous chemical formulations are known in the art for preparing inks, paints, and other coating compositions. Every such composition in the art that contains inorganic pigments in particulate form can be employed to formulate an ink, paint, or other coating composition with the luminescent chelate described supra serving as the pigment. The luminescent chelate may serve as the only pigment, or it may be combined with other pigments and particulate matter such as is known in the art of inks and coatings.

The composition is particularly useful for use in ink-jet printing ink employed for marking articles, particularly manufactured goods subject to counterfeiting.

In one embodiment, an ink composition comprises a carrier and a lanthanide chelate represented by the structure

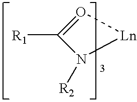

wherein Ln is Eu³⁺, Tb⁺³, Sm⁺³, or Dy⁺³; R₁ is selected from the group consisting of phenyl, naphthyl, thiophenyl, furanyl, pyridyl, C1 to C6 alkyl, anthrancenyl, and phenanthracenyl; and R₂ is selected from the group consisting of phenyl, naphthyl, pyridyl, C1 to C6 alkyl, anthrancenyl, and phenanthracenyl, and dimethylaminoethyl. In one embodiment. In one embodiment, Ln is Eu³⁺. In another embodiment, Ln is Tb³⁺. In one embodiment R₁ is thiophenyl or naphthyl. In one embodiment, R₂ is dimethylaminoethyl. In one embodiment, Ln is Eu³⁺, R₁ is thiophenyl, and R₂ is dimethylaminoethyl. In another embodiment, Ln is Eu³⁺, R₁ is naphthyl, and R₂ is dimethylaminoethyl. In another embodiment, Ln is Tb³⁺, R₁ is thiophenyl, and R₂ is dimethylaminoethyl. In another embodiment, Ln is Tb³⁺, R₁ is naphthyl, and R₂ is dimethylaminoethyl.

In an alternative embodiment, an ink composition comprises a lanthanide chelate coordination compound represented by the structure

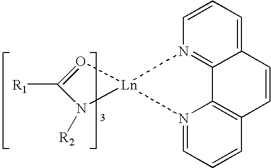

wherein Ln is Eu³⁺, Tb⁺³, Sm⁺³, or Dy⁺³; R₁ is selected from the group consisting of phenyl, naphthyl, thiophenyl, furanyl, pyridyl, C1 to C6 alkyl, anthrancenyl, and phenanthracenyl; and R₂ is selected from the group consisting of phenyl, naphthyl, pyridyl, C1 to C6 alkyl, anthrancenyl, and phenanthracenyl, and dimethylaminoethyl. In one embodiment, Ln is Eu³⁺. In another embodiment, Ln is Tb³⁺. In one embodiment R₁ is thiophenyl or naphthyl. In one embodiment, R₂ is dimethylaminoethyl. In one embodiment, Ln is Eu³⁺, R₁ is thiophenyl, and R₂ is dimethylaminoethyl. In another embodiment, Ln is Eu³⁺, R₁ is naphthyl, and R₂ is dimethylaminoethyl. In another embodiment, Ln is Tb³⁺, R₁ is thiophenyl, and R₂ is dimethylaminoethyl. In another embodiment, Ln is Tb³⁺, R₁ is naphthyl, and R₂ is dimethylaminoethyl.

In an alternative embodiment, an ink composition comprises a lanthanide chelate coordination compound represented by the structure

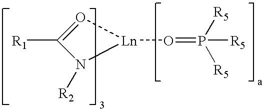

wherein a=1 or 2, Ln is Eu³⁺, Tb⁺³, Sm⁺³, or Dy₊₃; R₁ is selected from the group consisting of phenyl, naphthyl, thiophenyl, furanyl, pyridyl, C1 to C6 alkyl, anthrancenyl, and phenanthracenyl; and R₂ is selected from the group consisting of phenyl, naphthyl, pyridyl, C1 to C6 alkyl, anthrancenyl, and phenanthracenyl, and dimethylaminoethyl, and R₅ is aryl or C1 to C6 alkyl. In one embodiment, a=2. In one embodiment, Ln is Eu³⁺. In another embodiment, Ln is Tb³⁺. In one embodiment R₁ is thiophenyl or naphthyl. In one embodiment, R₂ is dimethylaminoethyl. In one embodiment, R₅ is phenyl. In one embodiment a=2, Ln is Eu³⁺, R₁ is thiophenyl, R₂ is dimethylaminoethyl, and R₅ is phenyl. In another embodiment, a=2, Ln is Eu³⁺, R₁ is naphthyl, R₂ is dimethylaminoethyl, and R₅ is phenyl. In another embodiment a=2, Ln is Tb³⁺, R₁ is thiophenyl, R₂ is dimethylaminoethyl and R₅ is phenyl. In another embodiment, a=2, Ln is Tb³⁺, R₁ is naphthyl, R₂ is dimethylaminoethyl and R₅ is phenyl.

In one embodiment, the carrier is a liquid. This embodiment represents a coating composition such as an ink suitable for, e.g., printing onto the surface of an article to be marked for identification purposes.

In a further embodiment, the carrier further comprises a polymer. In a still further embodiment, the polymer is dissolved in the liquid; that is, the carrier is a polymer solution.

In an alternative embodiment, the carrier is a polymer. This embodiment represents the composition in the form of a dried coating comprising a polymer binder and the luminescent chelate dispersed or dissolved therein.

The composition is not limited by the manner in which it is prepared or the specific form. Broadly, the composition is suitable for use in the preparation of a coating on a substrate. The coating so produced can be of any form. It can be in the form of a pattern such as printed text or other images, or it can be a coating of uniform thickness and appearance over a large area, such as a painted wall. It is anticipated that the composition will find its greatest utility in the area of product authentication, the utility is not limited thereto.

Additional ingredients such as electrolytes, humectants, and other additives such as are commonly incorporated into ink and other coating formulations also can be present without substantively altering the operability.

The coating compositions of the present invention to be useful exhibit a desirable balance among viscosity, solubility, compatibility of components, and wettability of the substrate. When the coating composition is an ink useful in printing operations, electrostatic ink deposition methods require that resistivity and polarizability also be considered. Further, coatings of the present invention, especially inks, are quick-drying and smear resistant, and resist abrasion.

In an ink embodiment according to the invention, the carrier liquid is used in an amount of from about 15% by weight to about 90% by weight, preferably in an amount of from about 30% by weight to about 60% weight of the composition. In a further embodiment, polymer is employed in an amount of from 0% to about 15% by weight of the ink composition, preferably, about 2% to about 10%. Excessive amount of the polymer can adversely affect the viscosity of the ink composition.

For some printing applications, such as xerography and ink jet, electrical resistivity can be an important property. In those applications, the composition of the present invention can further comprise an electrolyte to obtain the desired electrical resistivity of the jet ink composition. Any suitable electrolyte known to those of ordinary skill in the art can be used. Suitable electrolytes include but are not limited to alkali and alkaline earth metal salts such as lithium nitrate, lithium chloride, lithium thiocyanate, sodium chloride, potassium chloride, potassium bromide, calcium chloride, and the like, and amine salts such as ammonium nitrate, ammonium chloride, dimethylamine hydrochloride, hydroxylamine hydrochloride, and the like. It is important that the electrolyte salt not interfere with the luminescence.

The electrolyte is preferably present in the ink composition in the range of from about 0.1% to about 2%, more preferably 0.4% to 0.6%, by weight of the ink composition.

The composition of the present invention can further comprise a pH adjusting agent if needed to enhance the dissolution of the binder resin, or improve compatibility with the surface. The desired pH will be dependent upon the particular solvent used and also to some extent upon the other components employed. Any suitable pH adjusting agent, acid or base, can be used so as to maintain the pH of the ink composition in the range of from about 4.0 to about 8.0, preferably in the range of from about 4.5 to about 7.5.

The ink composition of the present invention can further comprise a humectant when the liquid is water in order to prevent drying of the ink during the printing operation, as well as during storage of the ink. Humectants are hydrophilic solvents preferably having boiling points in the range of from about 150° C. to about 250° C. Any suitable humectant known to those of ordinary skill in the art can be used. Examples of suitable humectants include glycols such as ethylene glycol, propylene glycol, glycerin, diglycerin, diethylene glycol, and the like, glycol ethers such as ethylene glycol dimethyl ether, ethylene glycol diethylether, cellosolve, diethylene glycol monoethylether (Carbitol), diethylene glycol dimethylether, and diethylene glycol diethylether, dialkylsulfoxides such as dimethylsulfoxide, and other solvents such as sulfolane, N-methylpyrrolidinone, and the like. Preferred humectants include propylene glycol and diethyleneglycol monoethylether.

Any suitable amount of the humectant can be used, preferably in an amount of from about 0.5% by weight to about 5% by weight of the ink composition, and more preferably in the amount of from about 1% by weight to about 3% by weight of the ink composition. Excessive use of the humectant is to be avoided because it will increase the toxicity and/or the viscosity of the ink.

The ink composition of the present invention can further comprise a suitable biocide to prevent growth of bacteria, mold or fungus. Any suitable biocide can be used. DOWICIL™ 150, 200, and 75, benzoate salts, sorbate salts, and the like, methyl p-hydroxybenzoate, and 6-acetoxy-2,2-dimethyl-1,3-dioxane are examples of suitable biocides. The biocide can be present in the ink of the instant invention in the range of from about 0.05% by weight to about 0.5% by weight, preferably in the amount of from about 0.1% by weight of to about 0.3% by weight of the jet ink composition.

The ink composition of the present invention can further comprise a defoamer to prevent foaming of the ink during its preparation, as well as during the printing operation. Any suitable defoamer known to those of ordinary skill in the art can be used, preferably those that are miscible with the liquid. Suitable defoamers include silicone defoamers and acetylenic defoamers. The amount used is preferably in the range of from about 0.01% by weight to about 1% by weight of the ink composition, and more preferably in the range of from about 0.05% by weight to about 0.35% by weight of the ink composition. The weight percentages given above refer to that of the active ingredient, and if the defoamer is sold in a diluted form, the amount of the diluted defoamer used will be proportionately increased. Excessive use of the defoamers is to be avoided because it can adversely affect the print quality such as adhesion to the coated substrate.

The ink composition of the present invention can be printed on any suitable substrate including papers, including coated papers, plastics, leather goods, fabrics, polymeric films, glass, ceramics, metals, and so forth.

To prepare an ink suitable for use in this invention, the luminescent chelate can be dispersed in the carrier liquid using a media mill, sand mill, high speed disperser, mulling plates or other means known in the art. The dispersion so produced should contain 10%-70% by weight, preferably 40%-60% by weight, of the luminescent chelate. A dispersing aid can be added equal to ½ to 1/10, preferably ¼ to ⅕, the weight of the particles, and the remainder should be the liquid carrier or mixture of suitable liquids.

In other embodiments, the luminescent chelate is simply dissolved in a suitable solvent, as recited supra, at solids concentrations of 10%-70% by weight, preferably 40%-60% by weight of the luminescent chelate.

In general, a preferred ink formulation is prepared by combining a liquid carrier, a polymeric binder soluble therein, and the luminescent chelate so that the resulting composition contains 10-70% by weight, preferably 40-60%, of the luminescent chelate, 0-15% by weight, preferably 2-10%, of polymer preferably dissolved in the solvent, and 15-90%, preferably 30-60% by weight of the carrier liquid. Optionally the composition can contain plasticizer of 0 to 5% and dispersant of 0 to 8%.

The ingredients can be combined in any order. The polymer can first be dissolved in the solvent followed by addition of the particulate material which is then dispersed or dissolved therein; the particulate material so added can be in the form of dry particles or a pre-prepared particle dispersion or solution. Alternatively, the particle dispersion or solution can be prepared first followed by addition of the polymer.

Varnishes according to the present invention may be formulated by adapting conventional methods known in the art. In a typical formulation, the particulate luminescent compound is combined in a viscous polymer solution consisting of ca. 10% of a fugitive solvent. Varnishes are conventionally applied by brushing, rolling, and spraying.

In order to prepare the chelates, a saturated aliphatic lanthanide carboxylate or fluorocarboxylate having 1 to 8 carbons, preferably 1 to 6, most preferably 1 to 3 carbons, is combined in a solvent with a compound represented by the formula

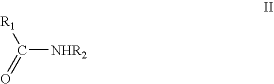

wherein R₁ is alkyl, aryl, or heteroaryl; and R₂ is alkyl, aminoalkyl; aryl or heteroaryl. Typically, the ingredients are mixed for a length of time necessary to achieve a desired amount of lanthanide amidate product.

A lanthanide fluorocarboxylate is preferred. More preferred is a lanthanide trifluoroacetate. Any lanthanide except promethium and lutetium is satisfactory for use in the process. Preferred lanthanides are those that luminesce in the visible portion of the electromagnetic spectrum, including europium, dysprosium, samarium, and terbium. The lanthanides suitable for use in the process are in the +3 valence states. Preferred are Eu(CF₃COO)₃, Dy(CF₃COO)₃, Sm(CF₃COO)₃ and Tb(CF₃COO)₃.

Suitable solvents are linear or cyclic alkanes, and aromatic hydrocarbons, both halogenated and non-halogenated. Preferred is dichloromethane.

Suitable aryls for use in R₁ or R₂ include but are not limited to phenyl, napthyl, anthracyl, or phenanthrenyl. Suitable heteroaryls include but are not limited to pyridinyl, quinolinyl, thionyl, furanyl, pyrolyl, oxazolyl, imidazolyl, pyrimidinyl, purinyl, nucleosides or keto tautomers of their enol forms. Suitable aryls or heteroaryls include substituted aryls or heteroaryls. Suitable substituents include but are not limited to the radicals such as alkyl, aryl, halo, alkoxy, halogenated alkyl, sulfanyl, secondary amino, or nitro.

Suitable aminoalkyl groups are represented by the formula

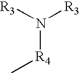

where each R₃ can independently be C1-C8 alkyl, preferably C1-C3, and R₄ can be C1-C8 alkenyl, preferably C2-C4. Most preferably, R₃ is methyl, and R₄ is ethenyl.

Suitable examples of compound (II) include but are not limited to compounds of the following formulae, wherein Q can be O or S. Further, any six ring aryl structure can be replaced by a pyridinyl ring. Any of the aromatic rings can also have substituents including but not limited to alkyl, aryl, halo, alkoxy, halogenated alkyl, sulfanyl, secondary amino, or nitro.

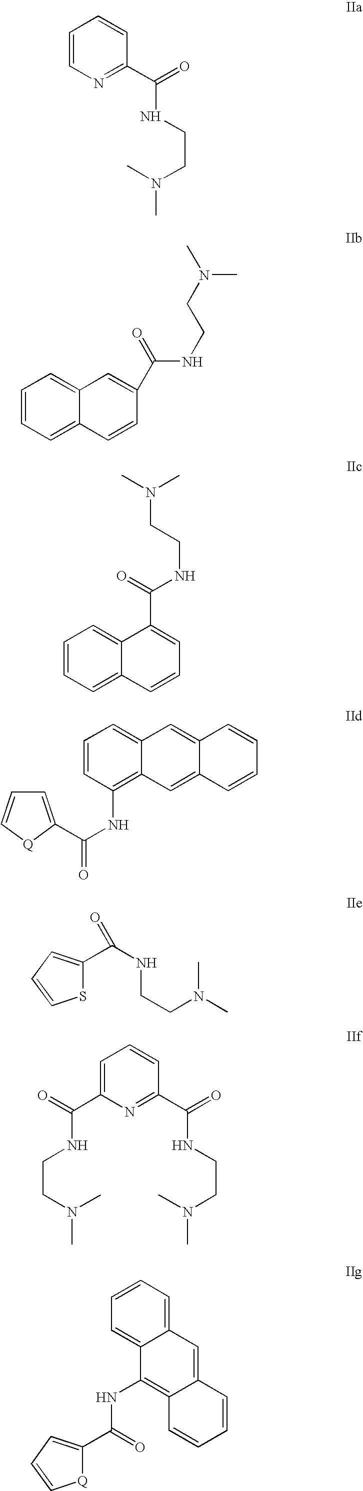

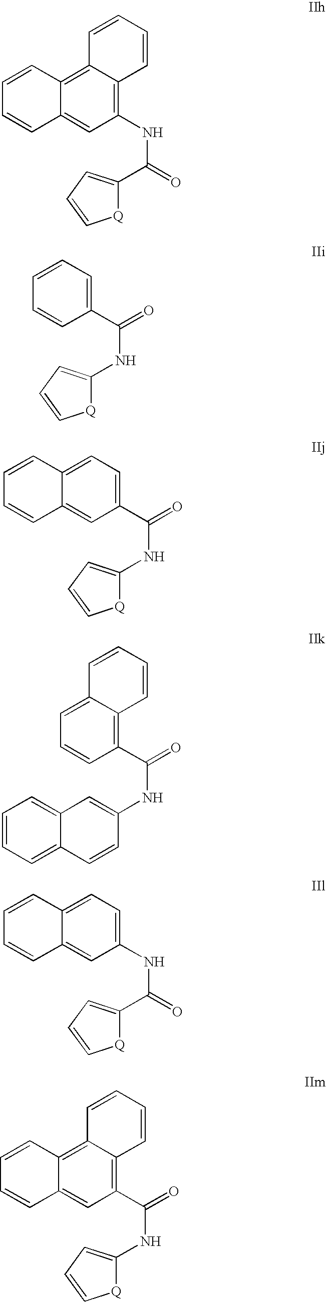

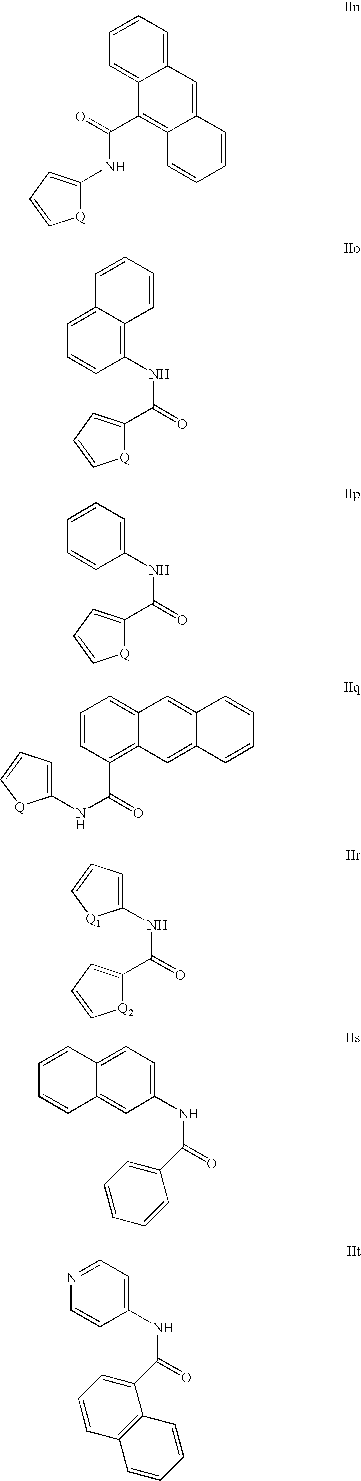

Also included are ligands having multiple heteroatoms in the aryl ring. For example pyrimidine, thiazole, oxazole, pyrrole, oxazole, imidazole, pyrimidine, purine, nucleosides or keto tautomers of their enol forms may be substituted for any of the aryl rings, Some combinations of R₁ and R₂ in the anionic amide ligand according to the process are recited in Table 1, supra. Any of the aromatic rings in the compositions of Table 1 can also have substituents including but not limited to alkyl, aryl, halo, alkoxy, halogenated alkyl, sulfanyl, secondary amino, or nitro.

Preferably the heteroaryl ring is thiophenyl, pyridinyl or furanyl. Preferably the aryl ring is phenyl, naphthyl, anthracyl, phenanthranyl. Preferably, the dialkylaminoethyl group is dimethylaminoethynyl.

Suitable compounds (IIs) are known in the art, and can be prepared according to the methods of the art. For example, compound (IIl) where Q is sulfur can be prepared according to the method of Buu-Hoi et al., Recueil des Travaux Chimiques des Pays-Bas et de la Belgique (1949) 68, 5-33. Compound (IIs) can be prepared according to the method of Yabunouchi et al., WO2006073059. Compound (IIk) can be prepared according to the method of Beckmann et al., Berichte der Deutschen Chemischen Gesellschaft [Abteilung] B: (1923), 56B, 341-354. Compound (IIc) can be prepared according to the method of Giannini et al., Farmaco, Edizione Scientifica (1973), 28(6), 429-447. Compound (IIf) can be prepared according to the method of Davies et al., J. Organometallic Chem. (1998), 550(1-2), 29-57.

It has been found satisfactory to react the reactants at room temperature. However, it is anticipated that higher temperatures will accelerate the reaction. In general the maximum temperature of reaction will be limited by the boiling point of a suitable solvent. In general, it is found satisfactory to combine reactants at concentrations in a 3:1 mole ratio of the amide ligand to the lanthanide starting precursor with the exception of ligand IIF where the reaction occurred in a 2:1 mole ratio of amide ligand to the lanthanide precursor. The generic structure of the aforementioned structures is described below:

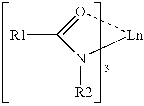

wherein Ln designates lanthanide, R₁ is alkyl, aryl, or heteroaryl; R₂ is alkyl, aminoalkyl, aryl or heteroaryl.

A neutral coordinating ligand can further be added to a solution of the tris-amidato-lanthanide chelate (III) formed as described supra. Suitable coordinating ligands include but are not limited to heteroaryl rings such as pyridine, pyridine-N-oxide, thiophene, furane, ketones, 1,10-phenathroline, tri-substituted phosphine oxides and di-substituted ethylene bridged diphosphine oxides as represented in the following structures, which can have substituents including but not limited to including but not limited to alkyl, aryl, halo, alkoxy, halogenated alkyl, sulfanyl, secondary amino, or nitro:

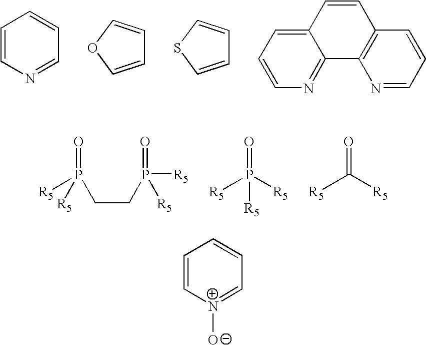

Coordination of these neutral ligands to the tris amidato lanthanide in the mole ratio range of 1:1 or 1:2 will yield the following representative structures:

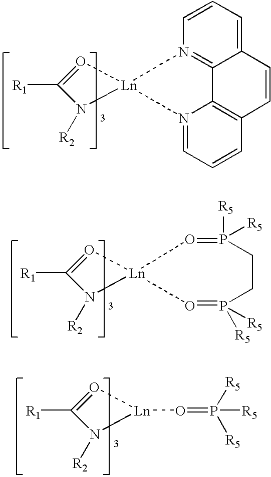

wherein R₁ is alkyl, aryl, or heteroaryl; R₂ is alkyl, aminoalkyl; aryl or heteroaryl, and each R₅ can independently be aryl or C1-C6 alkyl.

Further provided is a process wherein a surface of an article is contacted with a composition of the luminescent chelate as described hereinabove dispersed or dissolved in a carrier liquid. According to the process, the composition of the invention can be applied to a surface in any manner consistent with the viscosity and specific constitution of the composition, and suitable for the particular surface to be coated. The composition can be applied in the form of a paint: brushed on, rolled on, or sprayed on. The article can be dip-coated into the composition, or the composition can be applied to the surface by solution casting and drawn-down, or melt-casting. All such methods are well-known in the art.

Printing can be effected on any suitable surface such as papers, coated papers, plastics, leather goods, fabrics, polymeric films, glass, ceramics, and metals.

Further provided is a coated article wherein the article has a surface, the surface having disposed upon at least a portion of the surface the composition as described above. Optionally, the composition may be dried. Drying can be effected by allowing the composition to dry in an open environment at room temperature or any other method may be used as known to those in the art.

It is highly preferred that the coating further comprise a polymer that serves as a binder or matrix within which the luminescent chelate is dissolved or dispersed.

The articles comprise any coatable surface, preferably any printable surface. Suitable coatable surfaces include but are not limited to metallic surfaces, such as automobile body parts, coins, and paneling; ceramic surfaces, including glazed surfaces; glass; stone such as marble; molded plastic and fiberglass as in electronics housings and circuit boards, molded sheeting, polymeric films, leather goods, fabrics including textile goods, and canvas; papers, including coated papers, currencies, bonds, securities, and contracts.

### EXAMPLES

### Example 1

### A. Synthesis of thiophene-2-carboxylic acid (2-dimethylamino-ethyl)-amide

5.31 g of 2-thenoyl chloride (TCI America) was dissolved in 100 ml of anhydrous acetonitrile. 5.51 ml of N,N-dimethylamino-ethane diamine was added in dropwise to the solution so formed. The resulting reaction mixture was stirred for 12 h and then refluxed for 2 h at 82° C. 100 ml of distilled water and 5 ml of concentrated ammonium hydroxide were added along with 100 ml of diethylether in a separatory funnel. The phases were separated and the aqueous phase was washed with 100 ml of dichloromethane. The organic fractions were collected and dried with magnesium sulfate and the solvent was removed under reduced pressure to yield a white solid. Yield 82% (8.12 g; 41.00 mmol)

¹H NMR (CD₃CN): δ 7.56-7.54 (m, 2H), 7.09-7.07 (m, 2H), 3.39 (q, 2H), 2.43 (t, 2H), 2.19 (s 6H).

¹³C NMR (CD₃CN): δ 162.64, 140.97, 131.24, 128.80, 128.61, 59.16, 45.77, 38.47.

### B. Synthesis of tris[thiophene-2-carboxylic acid (2-dimethylamino-ethyl)-amidate]europium

In a 250 ml round-bottom Schlenk flask, 25 g of europium (III) trifluoroacetate hydrate (Alfa Aesar) was heated under vacuum (30 mTorr) in a sand bath to 100° C. for a period of 12 h. The flask was back filled with Ar and was stored in an inert atmosphere until further use. The yield after

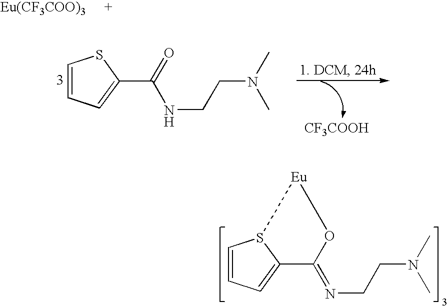

dehydration was quantitative.

1.473 g of the anhydrous europium(III) trifluoroacetate prepared was dissolved in 50 ml of anhydrous dichloromethane. To the solution so formed, 1.785 g of thiophene-2-carboxylic acid (2-dimethylamino-ethyl)-amide was added and the resulting solution was stirred for 24 h. The solvent was removed under reduced pressure and the white solid was washed with anhydrous hexane. The white precipitate was dried to yield 1.84 g (69%; 746.77 g/mol) of final product.

¹H NMR (CD₂Cl₂): δ 7.54 (m, 1H), 7.49 (m, 1H), 7.08 (m, 1H), 3.54 (q, 2H), 2.68 (t, 2H), 2.41 (s, 6H)

¹³C NMR (CD₂Cl₂): δ 162.2, 130.16, 128.17, 127.99, 58.30, 45.02, 36.88.

Elemental Analysis [EuC₂₇H₃₆N₆O₃S₃]: calculated. (found) H 4.89 (4.79), C 43.77 (42.85), N 11.34 (11.11)

### C. Synthesis of tris[thiophene-2-carboxylic acid (2-dimethylamino-ethyl)-amidate]bis(triphenylphosphine oxide) europium

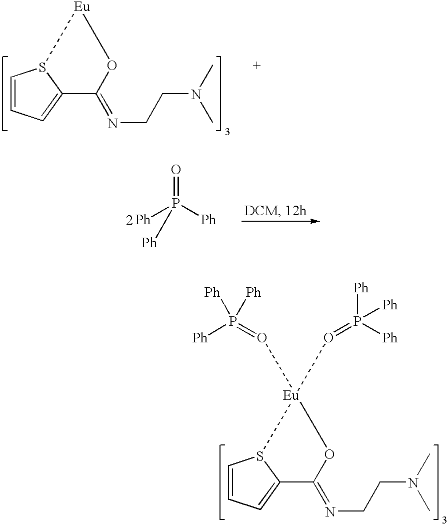

2.24 g (3.0 mmol; 746.77 g/mol) of the Eu[C9H13N2OS]3 of Example 9 was combined with 1.67 g of triphenylphosphine oxide in 25 ml of anhydrous dichloromethane. The solution so formed turned to a clear slightly yellow color upon addition of the triphenylphosphine oxide. The solution was stirred at room temperature for 12 h before removing the solvent under reduced pressure at which point a waxy oil was obtained. The residue was washed with anhydrous hexane and dried under vacuum. Yield 2.85 g (73%).

¹H NMR (CD₂Cl₂): δ 7.62, 7.52, 7.48, 7.44, 7.07, 3.68, 3.64, 2.87, 2.54, 1.81

¹³C NMR (CD₂Cl₂): δ 139.85, 132.24, 130.34, 128.90, 128.60, 128.04, 68.15, 58.38, 44.84, 25.93.

³¹P NMR (CD₂Cl₂): δ 27.71

Elemental Analysis [EuC₆₃H₆₆N₆O₅S₃P₂]: calculated. (found) H5.13 (5.06), C 58.32 (57.61), N 6.48 (6.40)

### D. Preparation of Coated Article

A 0.2 M solution of tris[thiophene-2-carboxylic acid (2-dimethylamino-ethyl)-amidate]bis(triphenylphosphine oxide) europium was prepared in toluene by dissolving 0.10 g of europium complex in 4 ml of toluene.

The reservoir of a MicroFab Jet Lab II (MicroFab Technologies, Plano, Tex.) ink jet printer was filled with the solution, and a 1 cm² area was printed onto at least a portion of the surface of an Avery® 8160 adhesive-back label using a 60 micron diameter nozzle printing tip at a 400 Hz frequency and using the waveform parameters shown in Table 2:

TABLE 2

| | | |
|---|---|---|
| rise | 1 | microsecond |
| dwell | 3 | microseconds |
| fall | 1 | microsecond |
| echo dwell | 3 | microseconds |
| final rise | 1 | microsecond |
| dwell voltage | 43 | V |
| echo voltage | −43 | V |
| frequency | 400 | Hz. |

The labels were left to dry on a lab bench in air at room temperature. After drying, the printed coating was illuminated at 365 nm using a UV lamp (Entela model UVL-56; 6W, 365 nm wavelength). Pink/red luminescence known to be characteristic of europium (III) was visually observed.

### Example 2

### A. Synthesis of tris[thiophene-2-carboxylic acid (2-dimethylamino-ethyl)-amidate]terbium

1.01 g of anhydrous terbium(III) acetate, purchased from Alfa Aesar was dehydrated in the manner of the europium fluoroacetate of Example 1, then dissolved in 50 ml of anhydrous dichloromethane. To the solution, 1.785 g of the thiophene-2-carboxylic acid (2-dimethylamino-ethyl)-amide of Example 1 was added and stirred for 24 h. The solvent was removed under reduced pressure and the white solid was washed with anhydrous hexane. The white precipitate was dried to yield 1.78 g (79%; 750.71 g/mol) of final product.

¹H NMR (CD₂Cl₂): δ 7.54 (m, 1H), 7.49 (m, 1H), 7.08 (m, 1H), 3.54 (q, 2H), 2.68 (t, 2H), 2.41 (s, 6H)

¹³C NMR (CD₂Cl₂): δ 162.2, 130.16, 128.17, 127.99, 58.30, 45.02, 36.88.

Elemental Analysis [TbC₂₇H₃₆N₆O₃S₃]: calculated. (found) H 4.85 (5.00), C 43.37 (42.34), N 11.34 (10.97)

### B. Preparation of Coated Article

A 0.03 M solution of the prepared tris[thiophene-2-carboxylic acid (2-dimethylamino-ethyl)-amidate]terbium was prepared in ethylene glycol dimethyl ether by dissolving 0.10 g of terbium complex in 4 ml of ethylene glycol dimethyl ether.

The solution was printed onto at least a portion of the surface of an Avery® 8160 adhesive-back label by filling the reservoir of a syringe with the prepared solution and then dispensing the solution through the syringe onto the label. After drying, the coating was illuminated at 365 nm using the Entela UV lamp of Example 1. Green luminescence known to be characteristic of terbium (III) was visually observed.

### Example 3

### A. Synthesis of naphthalene-1-carboxylic acid (2-dimethylamino-ethyl)-amide

9.53 g of 1-Naphthyl carbonyl chloride (TCI America) was dissolved in 100 ml of anhydrous acetonitrile and subsequently, 5.51 ml of N,N-dimethylamino-ethane diamine (Sigma-Aldrich) was added dropwise. The reaction was stirred for 12 h and then refluxed for 2 h at 82° C. 100 ml of distilled water and 5 ml of concentrated ammonium hydroxide were added along with 100 ml of diethylether in a separatory funnel. The phases were separated and the aqueous phase was washed with 100 ml of dichloromethane. The organic fractions were then collected and dried with magnesium sulfate and the solvent was removed under reduced pressure to yield a white solid. Yield 10.63 g (43.87 mmol; 88%).

¹H NMR (CD₃CN): δ 8.29-8.27 (m, 1H), 7.93-7.88 (m, 2H), 7.56-7.50 (m, 3H), 7.47-7.44 (m, 1H), 7.03 (br, 1H), 3.46 (q, 2H), 2.46 (t, 2H), 2.21 (s, 6H)

¹³C NMR (CD₃CN): δ 169.89, 136.20, 134.66, 131.13, 130.95, 129.25, 127.74, 127.31, 126.54, 125.98, 125.93, 59.08, 45.75, 38.52

### B. Synthesis of tris[naphthalene-1-carboxylic acid (2-dimethylamino-ethyl)-amidate]europium

1.47 g (3 mmol, 490.99 g/mol) of the anhydrous europium (III) trifluoroacetate of Example 1 and 2.18 g of naphthalene-1-carboxylic acid

(2-dimethylamino-ethyl)-amide (9 mmol), as prepared supra, were combined in 42 ml of anhydrous dichloromethane forming a solution. The solution was stirred for 12 h and the solvent was removed under reduced pressure to yield a white solid. The white solid was washed with 3×10 ml aliquots of anhydrous diethylether and was then dried under vacuum.

Yield 55% (1.44 g; 875.85 g/mol).

¹H NMR (CD₂Cl₂): δ 8.31 (br), 7.90 (d), 7.86 (d), 7.66 (m), 7.52 (m), 7.43 (m), 3.83 (br), 3.19 (br), 2.77 (s), 1.28 (m), 0.89 (t)

¹³C NMR (CD₂Cl₂): δ 134.09, 131.04, 130.59, 128.63, 127.25, 126.66, 125.85, 125.15, 58.40, 44.54, 36.58, 32.25, 29.40, 23.06, 14.26.

Elemental Analysis [EuC₄₅H₅₁N₆O₃]: calculated. (found) H 5.86 (5.97), C 61.71 (60.46), N 9.59 (9.40)

### C. Preparation of Coated Article

A 0.03 M solution of the prepared tris[naphthalene-1-carboxylic acid (2-dimethylamino-ethyl)-amidate]europium was prepared in ethylene glycol dimethyl ether by dissolving 0.10 g of the europium complex in 4 ml of ethylene glycol dimethyl ether. The solution was printed in the manner of Example 2 onto an Avery® 8160 adhesive-back label. After drying, the coating so deposited was illuminated at 365 nm using a Entela UV lamp of Example 1. Pink/red luminescence known to be characteristic of europium (III) was visually observed.

What is claimed is:

1. A composition comprising a carrier and a luminescent chelate wherein the lanthanide chelate comprises a lanthanide and a ligand wherein the ligand being represented by the formula 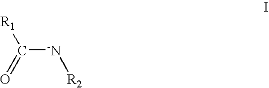
wherein R₁ is alkyl, aryl, or heteroaryl; and R₂ is alkyl, aminoalkyl, aryl or heteroaryl.

2. The composition of claim 1 wherein the lanthanide is selected from the group consisting of Eu³⁺, Tb³⁺, Sm³⁺, and Dy³⁺.

3. The composition of claim 1 wherein R₁ and R₂ are each independently selected from phenyl, napthyl, anthracyl, phenanthrenyl thiophenyl, pyridinyl, furanyl, and dialkylaminoethyl.

4. The composition of claim 3 wherein R₂ is dimethylaminoethyl.

5. The composition of claim 1 further comprising a neutrally charged coordinating ligand.

6. The composition of claim 5 wherein the neutrally charged coordinating ligand is selected from pyridine, pyridine-N-oxide, thiophene, furane, ketones, 1,10-phenathroline, aryl, C1-C6 alkyl-tri-substituted phosphine oxides and disubstituted-1,2-ethyldiphosphine oxide.

7. The composition of claim 1 wherein the carrier comprises a liquid.

8. The composition of claim 7 wherein the carrier further comprises a polymer.

9. A process comprising disposing on at least a portion of a surface of an article a composition comprising
a carrier and a luminescent chelate forming a coating, the luminescent chelate comprising a lanthanide and a ligand, the ligand being represented by the formula 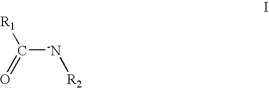
wherein R₁ is alkyl, aryl, or heteroaryl; R₂ is alkyl, aminoalkyl; aryl or heteroaryl, thereby forming upon at least a portion of the surface of the article the coating, optionally drying the coating.

10. The composition of claim 5 wherein the lanthanide chelate is a coordination compound represented by the structure 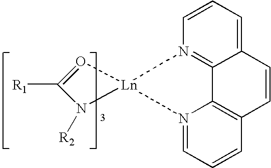
wherein Ln is Eu³⁺, Tb⁺³, Sm⁺³, or Dy⁺³; R₁ is selected from phenyl, naphthyl, thiophenyl, furanyl, pyridyl, C1 to C6 alkyl, anthrancenyl, or phenanthracenyl; and R₂ is selected from phenyl, naphthyl, pyridyl, C1 to C6 alkyl, anthrancenyl, phenanthracenyl, or dimethylaminoethyl.

11. The composition of claim 10 wherein R₁ is thiophenyl or naphthyl and R₂ is dimethylaminoethyl.

12. The composition of claim 10 wherein the lanthanide chelate is a coordination compound represented by the structure 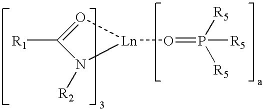
wherein a=1 or 2, Ln is Eu³⁺, Tb³⁺, Sm³⁺, or Dy³⁺; R₁ is selected from phenyl, naphthyl, thiophenyl, furanyl, pyridyl, C1 to C6 alkyl, anthrancenyl, or phenanthracenyl; R₂ is selected from phenyl, naphthyl, pyridyl, C1 to C6 alkyl, anthrancenyl, phenanthracenyl, ordimethylaminoethyl, and R₅ is aryl or C1 to C6 alkyl.

13. The composition of claim 12 wherein a=2.

14. The composition of claim 12 wherein Ln is Eu³⁺ or Tb³⁺.

15. The composition of claim 12 wherein R₁ is thiophenyl or naphthyl; R₂ is dimethylaminoethyl; and R₅ is phenyl.

16. An article having a surface comprising a coating on at least a portion of the surface wherein the coating comprises
a carrier and a luminescent chelate forming a coating, the luminescent chelate comprising a lanthanide and a ligand, the ligand being represented by the formula 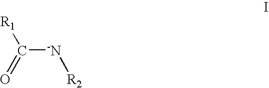
wherein R₁ is alkyl, aryl, or heteroaryl; R₂ is alkyl, aminoalkyl; aryl or heteroaryl, optionally drying the coating.
